(19) United States
(12) Patent Application Publication
(10) Pub. No.: US 2024/0140381 A1
(43) Pub. Date: May 2, 2024

(54) BRAKE APPARUTUS

(71) Applicant: HL MANDO CORPORATION, Gyeonggi-do (KR)

(72) Inventors: Donghyun YOUN, Gyeonggi-do (KR); Segyun LEE, Gyeonggi-do (KR); Mankyu LEE, Gyeonggi-do (KR); Seonkyu SEO, Seoul (KR)

(21) Appl. No.: 18/374,580

(22) Filed: Sep. 28, 2023

(30) Foreign Application Priority Data
Nov. 1, 2022 (KR) 10-2022-0143893

(51) Int. Cl. B60T 8/88; B60T 8/94; B60T 13/14; B60T 13/68; H02P 27/06

(52) U.S. Cl. CPC B60T 8/885; B60T 8/94; B60T 13/148; B60T 13/686; H02P 27/06; B60T 2270/402

(57) ABSTRACT

A brake apparatus includes a first processor configured to output a first control signal based on an output signal of a parking switch, a second processor, a first parking brake driver configured to drive a first parking brake motor and a second parking brake motor based on the first control signal, and a second parking brake driver. The first processor transmits a first periodic signal to the parking switch during a normal operation of the first processor. The parking switch transmits a second periodic signal to the second processor in response to the first periodic signal received from the first processor. The second processor does not output the second control signal in response to the second periodic signal, and outputs a second control signal in response to not receiving the second periodic signal. The second parking brake driver drives the second parking brake motor based on the second control signal.

### CROSS-REFERENCE TO RELATED APPLICATION

This application claims the benefit of Korean Patent Application No. 10-2022-0143893, filed on Nov. 1, 2022 in the Korean Intellectual Property Office, the disclosure of which is incorporated herein by reference in its entirety.

### BACKGROUND

### 1. Technical Field

Embodiments of the present disclosure generally relate to a brake apparatus with improved reliability, stability, and robustness.

### 2. Description of the Related Art

A vehicle is essentially equipped with a brake apparatus to perform braking, and various types of brake apparatuses have been used for safety of users and passengers.

In a conventional brake apparatus, when a user depresses a brake pedal, a mechanically connected booster provides hydraulic pressure (for example, brake oil pressure) required for braking to wheel cylinders.

However, as a market demand for various braking functions to be implemented in detailed response to an operational environment of the vehicle is increasing, a brake apparatus including a hydraulic pressure supply unit has recently been developed which supplies hydraulic pressure required for braking to the wheel cylinders by receiving an electrical signal indicating a user's intent to brake from a pedal sensor when the user depresses the brake pedal.

In addition, a brake apparatus including a motor-mounted caliper that generates a braking force for parking by receiving an electrical signal indicating a user's intent to park from a parking switch when the user presses the parking switch has become popular.

### SUMMARY

Therefore, it is an aspect of the present disclosure to provide a brake apparatus capable of improving reliability, stability, and robustness of a parking brake.

it is another aspect of the present disclosure to provide a brake apparatus including a main processor and a main driver for controlling and driving a parking brake, as well as a redundant processor and a redundant driver.

Additional aspects of the disclosure will be set forth in part in the description which follows and, in part, will be obvious from the description, or may be learned by practice of the disclosure.

A brake apparatus according to one aspect of the present disclosure, includes a first processor configured to output a first control signal based on an output signal of a parking switch, a second processor configured to output a second control signal based on the output signal of the parking switch, a first parking brake driver configured to drive a first parking brake motor and a second parking brake motor based on the first control signal, and a second parking brake driver configured to drive the second parking brake motor based on the second control signal. The first processor transmits a first periodic signal to the parking switch during a normal operation. The parking switch transmits a second periodic signal to the second processor based on receiving the first periodic signal. The second processor prevents outputting the second control signal based on receiving the second periodic signal.

The parking switch may prevent transmitting the second periodic signal to the second processor based on not receiving the first periodic signal. The second processor may output the second control signal based on receiving the output signal of the parking switch and not receiving the second periodic signal.

The first parking brake driver may include a first inverter configured to provide a driving current to the first parking brake motor, and a first gate driver configured to drive the first inverter based on the first control signal. The second parking brake driver may include a second inverter configured to provide a driving current to the second parking brake motor, and a second gate driver configured to drive the second inverter based on the second control signal. The first gate driver may further drive the second inverter based on the first control signal.

The second parking brake driver may further include a first switch arranged between the first gate driver and the second inverter and turned on or off in response to a first on/off signal from the first processor, and a second switch arranged between the second gate driver and the second inverter and turned on or off in response to a second on/off signal from the second processor.

The first processor may output an on signal to the first switch during the normal operation. The second processor may output an off signal to the second switch based on receiving the second periodic signal.

The first switch may be turned off while the first processor is not operating normally. The second processor may output an on signal to the second switch based on not receiving the second periodic signal.

The second parking brake driver may drive the first parking brake motor and the second parking brake motor based on the second control signal.

The first parking brake driver may include a first inverter configured to provide a driving current to the first parking brake motor, and a first gate driver configured to drive the first inverter based on the first control signal. The second parking brake driver may include a second inverter configured to provide a driving current to the second parking brake motor, a second gate driver configured to drive the second inverter based on the second control signal, and a third gate driver configured to drive the first inverter based on the second control signal. The first gate driver may further drive the second inverter based on the first control signal.

The first parking brake driver may further include a third switch arranged between the first gate driver and the first inverter and turned on or off in response to a third on/off signal from the first processor, and a fourth switch arranged between the third gate driver and the first inverter and turned on or off in response to a fourth on/off signal from the second processor.

The first processor may output an on signal to the third switch during the normal operation. The second processor may output an off signal to the fourth switch based on receiving the second periodic signal.

The third switch may be turned off while the first processor is not operating normally. The second processor may output an on signal to the fourth switch based on not receiving the second periodic signal.

The first periodic signal and the second periodic signal may each include a periodic pulse.

The brake apparatus may further include a hydraulic pressure supply unit arranged to supply hydraulic pressure of a pressurized medium to a plurality of wheel cylinders, and a hydraulic pressure control unit configured to control a flow path extending from the hydraulic pressure supply unit to the plurality of wheel cylinders. The first processor may control the hydraulic pressure supply unit and the hydraulic pressure control unit to supply the hydraulic pressure to the plurality of wheel cylinders based on an output signal of a brake pedal.

The hydraulic pressure supply unit may include a cylinder block, a piston movably arranged within the cylinder block, and a hydraulic pressure motor configured to reciprocate the piston.

The hydraulic pressure control unit may include a valve block having a plurality of valves arranged in the flow path.

A brake apparatus according to another aspect of the present disclosure includes a first processor configured to output a first control signal based on an output signal of a parking switch, a second processor configured to output a second control signal based on the output signal of the parking switch, a first parking brake driver configured to drive a first parking brake motor and a second parking brake motor based on the first control signal, and a second parking brake driver configured to drive the second parking brake motor based on the second control signal. The first processor transmits a first periodic signal to the first parking brake driver during a normal operation. The first parking brake driver transmits a second periodic signal to the parking switch based on receiving the first periodic signal. The parking switch transmits a third periodic signal to the second processor based on receiving the second periodic signal. The second processor prevents outputting the second control signal based on receiving the third periodic signal.

The parking switch may prevent transmitting the third periodic signal to the second processor based on not receiving the second periodic signal. The second processor may output the second control signal based on receiving the output signal of the parking switch and not receiving the third periodic signal.

A brake apparatus according to still another aspect of the present disclosure includes a first processor configured to output a first control signal based on an output signal of a parking switch, a second processor configured to output a second control signal based on the output signal of the parking switch, a connection switch arranged on a signal line connecting the first processor and the second processor, a first parking brake driver configured to drive a first parking brake motor and a second parking brake motor based on the first control signal, and a second parking brake driver configured to drive the second parking brake motor based on the second control signal. The first processor transmits a periodic signal to the second processor through the signal line during a normal operation. The second processor prevents outputting the second control signal based on receiving the periodic signal.

The second processor may output the second control signal based on receiving the output signal of the parking switch and not receiving the periodic signal.

The connection switch may be controlled by an external device.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 illustrates a configuration of a brake apparatus according to an embodiment of the present application;

FIG. 2 illustrates a configuration of a control circuit included in a brake apparatus according to an embodiment of the present disclosure;

FIG. 3 is a block diagram for illustrating a processor and a parking brake driver of a control circuit included in a brake apparatus according to an embodiment of the present disclosure;

FIG. 4 is a block diagram for illustrating a processor and a parking brake driver of a control circuit included in a brake apparatus according to an embodiment of the present disclosure;

FIG. 5 is a block diagram for illustrating a processor and a parking brake driver of a control circuit included in a brake apparatus according to a still another embodiment of the present disclosure;

FIG. 6 is a block diagram for illustrating a processor and a parking brake driver of a control circuit included in a brake apparatus according to still another embodiment of the present disclosure;

FIG. 7 is a block diagram of illustrating a processor and a parking brake driver of a control circuit included in a brake apparatus according to still another embodiment of the present disclosure; and

FIG. 8 is a block diagram for illustrating a processor and a parking brake driver of a control circuit included in a brake apparatus according to still another embodiment of the present disclosure.

### DETAILED DESCRIPTION

The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. The progression of processing operations described is an example; however, the sequence of and/or operations is not limited to that set forth herein and may be changed as is known in the art, with the exception of operations necessarily occurring in a particular order. In addition, respective descriptions of well-known functions and constructions may be omitted for increased clarity and conciseness.

Additionally, exemplary embodiments will now be described more fully hereinafter with reference to the accompanying drawings. The exemplary embodiments may, however, be embodied in many different forms and should not be construed as being limited to the embodiments set forth herein. These embodiments are provided so that this disclosure will be thorough and complete and will fully convey the exemplary embodiments to those of ordinary skill in the art. Like numerals denote like elements throughout.

It will be understood that, although the terms first, second, etc. may be used herein to describe various elements, these elements should not be limited by these terms. These terms are only used to distinguish one element from another. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present.

The terminology used herein is for the purpose of describing particular embodiments only and is not intended to be limiting. As used herein, the singular forms “a,” “an,” and “the,” are intended to include the plural forms as well, unless the context clearly indicates otherwise.

The expression, “at least one of a, b, and c,” should be understood as including only a, only b, only c, both a and b, both a and c, both b and c, or all of a, b, and c.

Reference will now be made in detail to the exemplary embodiments of the present disclosure, examples of which are illustrated in the accompanying drawings, wherein like reference numerals refer to like elements throughout.

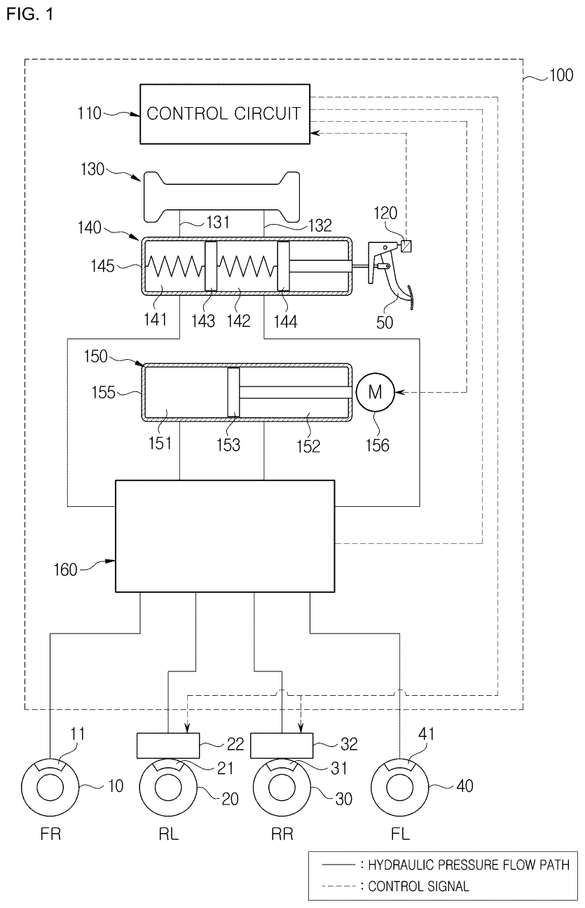

FIG. 1 illustrates a configuration of a brake apparatus according to an embodiment of the present application.

As illustrated in FIG. 1, a vehicle may have a plurality of wheels 10, 20, 30, and 40 arranged to enable the vehicle to travel.

Each of the plurality of wheels 10, 20, 30, and 40 may be provided with a brake disc rotating together with each of the wheels 10, 20, 30, and 40, and a brake caliper for braking rotation of each of the brake discs.

Each of a plurality of wheel cylinders 11, 21, 31, and 41 may be arranged in a respective brake caliper. The wheel cylinders 11, 21, 31, and 41 may receive a pressurized medium provided by a brake apparatus 100, and move the brake calipers to press the brake discs by pressure of the pressurized medium.

Each of the wheel cylinders 11, 21, 31, and 41 may be arranged in a corresponding each of the plurality of wheels 10, 20, 30, and 40. For example, a first wheel cylinder 11 may be arranged on a first wheel 10 that is arranged on a front right side of the vehicle, and a second wheel cylinder 21 may be arranged on a second wheel 20 that is arranged on a rear left side of the vehicle. In addition, a third wheel cylinder 31 may be arranged on a third wheel 30 that is arranged on a rear right side of the vehicle, and a fourth wheel cylinder 41 may be arranged on a fourth wheel 40 that is arranged on a front left side of the vehicle.

A parking brake module 22, 32 may be arranged on at least some of the plurality of wheels 10, 20, 30, and 40. For example, the second wheel 20 and the third wheel 30, which are arranged at the rear of the vehicle, may be arranged with a first parking brake module 22 and a second parking brake module 32, respectively.

Each of the first parking brake module 22 and the second parking brake module 32 may move the brake caliper to press the brake disc by an electro-mechanical force without hydraulic pressure. Each of the first parking brake module 22 and the second parking brake module 32 may include a motor having a rotational shaft and a spindle configured to reciprocate by rotation of the rotational shaft. The brake caliper may be moved to press the brake disc by the movement of the spindle.

Each of the first parking brake module 22 and the second parking brake module 32 may move the brake caliper to press the brake disc in response to an engagement signal from a control circuit 110, and may also move the brake caliper to release from the brake disc in response to a disengagement signal from the control circuit 110.

The brake apparatus 100 may detect a user's intent to brake and provide hydraulic pressure of the pressurized medium to the plurality of wheel cylinders 11, 21, 31, and 41 in response to the user's intent to brake. For example, the brake apparatus 100 may detect the driver's movement or input representative of the user's intent brake and provide hydraulic pressure of the pressurized medium to the plurality of wheel cylinders 11, 21, 31, and 41 in response to the driver's movement or input representative of the user's intent brake.

The brake apparatus 100 may include a pedal sensor 120, a reservoir 130, a master cylinder 140, a hydraulic pressure supply unit 150, a hydraulic pressure control unit 160, and the control circuit 110. One or more of the pedal sensor 120, the reservoir 130, the master cylinder 140, the hydraulic pressure supply unit 150, the hydraulic pressure control unit 160, and the control circuit 110 illustrated in FIG. 1 may not be essential configurations of the brake apparatus 100, and one or more of the configurations illustrated in FIG. 1 may be omitted.

The pedal sensor 120 may detect the displacement, a moving distance and/or a moving speed of the brake pedal 50 moving by the user's intent to brake, and output an electrical signal (pedal signal) that is dependent on the detected the displacement, moving distance and/or moving speed of the brake pedal 50.

The reservoir 130 may store a medium, such as brake oil. The reservoir 110 may be hydraulically connected to each component element to supply or receive the pressurized medium. The reservoir 130 may be fluidly connected to the master cylinder 140 through reservoir flow paths 131 and 132.

The master cylinder 140 may compress and discharge the pressurized medium received from the reservoir 110 in response to a pedal force or displacement of the brake pedal 50. The master cylinder 140 may include a first master chamber 141 and a second master chamber 142 formed by a cylinder block 145. In the first master chamber 141 and the second master chamber 142, a first master piston 143 and a second master piston 144 are movably arranged, respectively.

The hydraulic pressure supply unit 150 may generate the hydraulic pressure of the pressurized medium in response to the user's intent to brake. For example, the user's intent to brake may correspond a signal representative of sensing the user's intent to brake such as displacement of the brake pedal 50).

The hydraulic pressure supply unit 150 may include a cylinder block 155 receiving the pressurized medium, a hydraulic pressure piston 153 arranged to be reciprocally movable within the cylinder block 155, and hydraulic pressure chambers 151 and 152 divided by the hydraulic pressure piston 153. One or more of the cylinder block 155, the hydraulic pressure piston 153, and the hydraulic pressure chambers 151 and 152 may not be essential configurations of the hydraulic pressure supply unit 150, and one or more of them may be omitted.

Hydraulic pressure may be generated within the hydraulic pressure chambers 151 and 152 by the reciprocating movement of the hydraulic pressure piston 153. The hydraulic pressure generated from the hydraulic pressure chambers 151 and 152 may be transferred to the wheel cylinders 11, 21, 31, and 41 through the hydraulic pressure control unit 160.

The hydraulic pressure chambers 151 and 152 may include a first hydraulic pressure chamber 151 positioned in front of the hydraulic pressure piston 153 or farther from the motor 156 than a second hydraulic pressure chamber 152 (e.g. on the left of the hydraulic pressure piston 153 in FIG. 1) and the second hydraulic pressure chamber 152 positioned behind the hydraulic pressure piston 153 (on the right of the hydraulic pressure piston in FIG. 1).

The first hydraulic pressure chamber 151 Is formed by the inner surface of the cylinder block 155 and a front surface of the hydraulic pressure piston 153, and a volume of the first hydraulic pressure chamber 151 may change according to a movement of the hydraulic pressure piston 153. In addition, the second hydraulic pressure chamber 152 is formed by the inner surface of the cylinder block 155 and a rear surface of the hydraulic pressure piston 153, and a volume of the second hydraulic pressure chamber 152 may change according to a movement of the hydraulic pressure piston 153. The first hydraulic pressure chamber 151 and the second hydraulic pressure chamber 152 may each be fluidly connected to the hydraulic pressure control unit 160 by a hydraulic pressure flow path.

The hydraulic pressure supply unit 150 may include a hydraulic pressure motor 156 configured to generates a force for moving the hydraulic pressure piston. For example, the hydraulic pressure motor 156 generates a rotational force and the hydraulic pressure supply unit 150 may include a power conversion unit configured to selectively convert the rotational force of the hydraulic pressure motor 156 into a translational motion to linearly move the hydraulic pressure piston 153.

The hydraulic pressure control unit 160 may be arranged between the hydraulic pressure supply unit 150 and the wheel cylinders 11, 21, 31, and 41. The hydraulic pressure control unit 160 may include, for example, but not limited to, a plurality of hydraulic pressure flow paths extending from the hydraulic pressure supply unit 150 to each of the wheel cylinders 11, 21, 31, and 41, and a valve block arranged with a plurality of valves capable of allowing or blocking a flow of the pressurized medium in the plurality of hydraulic pressure flow paths.

The hydraulic pressure control unit 160 may control the hydraulic pressure flow paths to guide the hydraulic pressure generated by the hydraulic pressure supply unit 150 to the wheel cylinders 11, 21, 31, and 41, or may control the hydraulic pressure flow paths to return the hydraulic pressure from the wheel cylinders 11, 21, 31, and 41 to the hydraulic pressure supply unit 150.

For example, in response to an increase in stroke of the brake pedal 50, the hydraulic pressure control unit 160 may control the flow path to guide the hydraulic pressure generated in the first hydraulic pressure chamber 151 to the wheel cylinders 11, 21, 31, and 41 while the hydraulic pressure piston 153 is moving forward (e.g. in a direction away from the motor 156), and may also control the flow path to guide hydraulic pressure generated in the second hydraulic pressure chamber 152 to the wheel cylinders 11, 21, 31, and 41 while the hydraulic pressure piston 153 is moving backward (e.g. in a direction toward the motor 156) after moving forward. For example, in response to a decrease in the stroke of the brake pedal 50, the hydraulic pressure control unit 160 may control the flow path to return the medium in the wheel cylinders 11, 21, 31, and 41 to the first hydraulic pressure chamber 151 while the hydraulic pressure piston 153 is moving forward, and may also control the flow path to return the medium in the wheel cylinders 11, 21, 31, and 41 to the second hydraulic pressure chamber 152 while the hydraulic pressure piston 153 is moving backward after moving forward.

The control circuit 110 may include a plurality of semiconductor components or elements and may be, for instance, an electronic control unit (ECU) or the like. The control circuit 110 may include, for example, a plurality of processors and/or a plurality of memories.

The control circuit 110 may receive a pedal signal indicating a user's intent to brake from the pedal sensor 120, and transmit or provide an electrical signal to each of the hydraulic pressure supply unit 150 and the hydraulic pressure control unit 160 to supply or return the medium to the wheel cylinders 11, 21, 31, and 41 in response to the pedal signal.

In addition, the control circuit 110 may receive an engagement or disengagement signal from a parking switch that indicates a user's input for engaging or disengaging the parking brake, and provide an electrical signal (such as an engagement signal or disengagement signal) to the parking brake modules 22 and 32 in response to the engagement or disengagement signal to engage or disengage the parking brake.

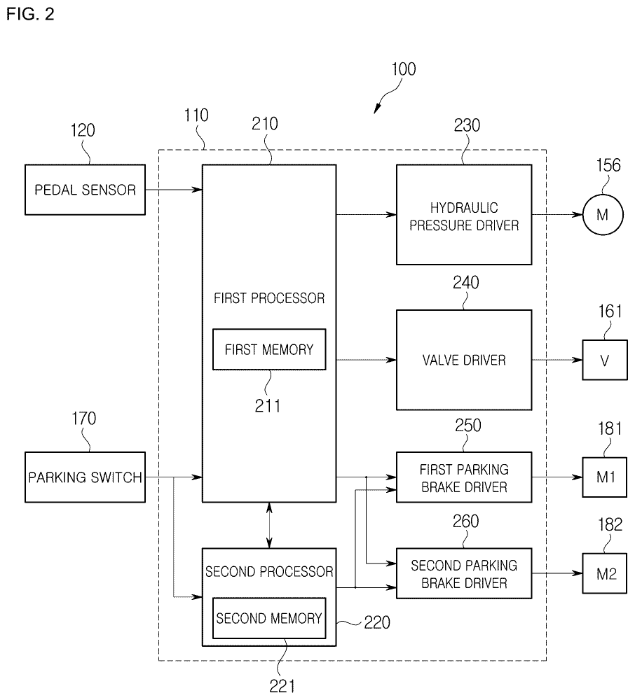

FIG. 2 illustrates a configuration of a control circuit included in a brake apparatus according to an embodiment of the present disclosure.

With reference to FIG. 2, the brake apparatus 100 may include the pedal sensor 120, a parking switch 170, the hydraulic pressure motor 156, a valve block 161, parking brake motors 181 and 182, and/or the control circuit 110. One or more of the pedal sensor 120, the parking switch 170, the hydraulic pressure motor 156, the valve block 161, the parking brake motors 181 and 182, and/or the control circuit 110 may not be essential configurations of the brake apparatus 100, and one or more of the configurations illustrated in FIG. 2 may be omitted.

The pedal sensor 120 may detect the displacement, moving distance and/or the moving speed of the brake pedal 50 moving by the user's intent to brake, as previously described, and provide an electrical signal (e.g. a pedal signal) indicating the detected displacement, moving distance and/or moving speed to the brake apparatus 100.

The parking switch 170 may be electrically opened or closed selectively by a user's parking command, and may transmit or provide an electrical signal (e.g. an engagement or disengagement signal) indicating the user's input for engaging or disengaging the parking brake to the brake apparatus 100.

The hydraulic pressure motor 156 may be included in the hydraulic pressure supply unit 150, and may be configured to generate power (for example, a rotational force) for the hydraulic pressure supply unit 150 to generate the hydraulic pressure of the pressurized medium. The rotational force provided by the hydraulic pressure motor 156 may be converted into a translational movement that can move the hydraulic pressure piston 153 by conversion means such as a screw-nut mechanism.

The valve block 161 is included in the hydraulic pressure control unit 160 and may be configured to control the flow path of the pressurized medium extending from the hydraulic pressure supply unit 150 to the wheel cylinders 11, 21, 31, and 41. For example, the valve block 161 may include a plurality of solenoid valves arranged on the flow path of the pressurized medium.

The parking brake motors 181 and 182 may be included in the parking brake modules 22 and 32, respectively. For example, the first parking brake motor 181 may be included in the first parking brake module 22, and the second parking brake motor 182 may be included in the second parking brake module 32. The parking brake motors 181 and 182 may generate power (e.g. a rotational force) for the parking brake modules 22 and 32 to brake the second wheel 20 and the third wheel 30. The rotational force provided by the parking brake motors 181 and 182 may be converted into a translational movement that can move the brake caliper by a conversion means such as a spindle and nut mechanism.

The control circuit 110 may provide electrical signals to provide the hydraulic pressure of the pressurized medium to the wheel cylinders 11, 21, 31, and 41 in response to the user's intent to brake input by the brake pedal 50, or may provide electrical signals to the parking brake modules 22 and 32 in response to the user's intent to park input by the parking switch 170.

The control circuit 110 may include a first processor 210, a second processor 220, a hydraulic pressure driver 230, a valve driver 240, a first parking brake driver 250, and a second parking brake driver 260. One or more of the first processor 210, the second processor 220, the hydraulic pressure driver 230, the valve driver 240, the first parking brake driver 250, and the second parking brake driver 260 may not be essential configurations of the control circuit 110, and one or more of the configurations illustrated in FIG. 2 may be omitted.

The first processor 210 may control the hydraulic pressure motor 156 of the hydraulic pressure supply unit 150 and/or the valve block 161 of the hydraulic pressure control unit 160 based on an electrical signal (e.g. a pedal signal) from the pedal sensor 120. In addition, the first processor 210 may control the first and second parking brake modules 22 and 32 based on an electrical signal (e.g. an engagement or disengagement signal) from the parking switch 170.

The first processor 210 may include a single semiconductor component element or a plurality of semiconductor components. The first processor 210 may include a single core or a plurality of cores within the semiconductor component(s) or element(s). In addition, the first processor 210 may be a micro controller unit (MCU), or the like.

The first processor 210 may include a first memory 211 configured to memorize or store programs and data for performing the braking and/or parking of the vehicle based on the user's intent to brake and/or park. Alternatively, the first memory 211 may not be included the first processor 210 and may be arranged outside of the first processor 210 and electrically connected to the first processor 210.

The first memory 211 may provide programs and data to the first processor 210 and store temporary data generated during computational operations of the first processor 210. The first memory 211 may include a volatile memory, such as a static random access memory (S-RAM) or a dynamic random access memory (D-RAM), and a non-volatile memory, such as a read only memory (ROM), an erasable programmable read only memory (EPROM), or a flash memory.

The first processor 210 may provide a control signal to the hydraulic pressure motor 156 and/or the valve block 161 based on the pedal signal from the pedal sensor 120, according to the program and data stored in the first memory 211. For instance, the first processor 210 may transmit or provide a driving signal to the hydraulic pressure motor 156 to generate hydraulic pressure, and provide a signal for opening or closing a valve to the valve block 161 to transfer or deliver hydraulic pressure to the wheel cylinders 11, 21, 31, and 41.

For example, the first processor 210 may receive the pedal signal from the pedal sensor 120 indicating an increase or decrease in the stroke of the brake pedal 50, and provide a control signal for controlling the hydraulic pressure motor 156 and/or the valve block 161 based on the received pedal signal. The first processor 210 may transmit or provide a control signal to the hydraulic pressure driver 230 to allow the hydraulic pressure supply unit 150 to generate the hydraulic pressure of the pressurized medium and transmit or provide a control signal to the valve driver 240 to allow the hydraulic pressure control unit 160 to guide the medium or hydraulic pressure to the wheel cylinders 11, 21, 31, and 41 in response to the pedal signal indicating the increase in the stroke of the brake pedal 50. In addition, the first processor 210 may provide a control signal to the hydraulic pressure driver 230 to allow the hydraulic pressure supply unit 150 to return hydraulic pressure of the pressurized medium and provide a control signal to the valve driver 240 to allow the hydraulic pressure control unit 160 to guide the medium or hydraulic pressure of the wheel cylinders 11, 21, 31, and 41 to the hydraulic pressure supply unit 150 in response to the pedal signal indicating the decrease in the stroke of the brake pedal 50.

The first processor 210 may control the first parking brake module 22 and the second parking brake module 32 installed on the second wheel 20 and the third wheel 30, respectively.

The first processor 210 may provide an engagement or disengagement signal to the first parking brake module 22 and/or the second parking brake module 32 to engage or disengage the parking brake according to the program and data stored in the first memory 211.

For example, the first processor 210 may receive a parking command to engage or disengage the parking brake, either directly from the parking switch 170 or indirectly through an in-vehicle communication network (NT), and transmit or provide an engagement signal or a disengagement signal to the first parking brake module 22 and/or the second parking brake module 32 in response to the received parking command. In response to the engagement signal from the first processor 210, each of the first and second parking brake modules 22 and 32 may restrain the brake discs to impede the rotation of the wheels. In response to the disengagement signal from the first processor 210, each of the first and second parking brake modules 22 and 32 may disengage the brake discs to allow the rotation of the wheels.

The first processor 210 may transmit and receive data and/or signals to and from the second processor 220 through various paths. For example, the first processor 210 may transmit and receive data and/or signals to and from the second processor 220 through a signal line connected between the first processor 210 and the second processor 220, or may transmit and receive data and/or signals to and from the second processor 220 through an other or external device connected in common with the second processor 220. In addition, the first processor 210 may transmit and receive data and/or signals to and from the second processor 220 through the in-vehicle communication network.

The first processor 210 may transmit and receive various data and/or signals to and from the second processor 220. For example, the first processor 210 may periodically transmit a signal (e.g., a pulse signal) to the second processor 220 during a normal operation of the first processor 210. The second processor 220 may receive a periodic signal (e.g., pulse signal) from the first processor 210, and may be deactivated while receiving the periodic signal from the first processor 210.

The second processor 220 may include a single semiconductor component or element or a plurality of semiconductors. The second processor 220 may include a single core or a plurality of cores within the semiconductor element. In addition, the second processor 220 may be a micro controller unit (MCU), or the like.

The second processor 220 may transmit and receive data and/or signals to and from the first processor 210 through various paths. For example, the second processor 220 may transmit and receive data and/or signals to and from the first processor 210 through a signal line connected between the first processor 210 and the second processor 220, or may transmit and receive data and/or signals to and from the first processor 210 through an other or external device connected in common with the first processor 210. In addition, the second processor 220 may transmit and receive data and/or signals to and from the first processor 210 through the in-vehicle communication network.

The second processor 220 may transmit and receive various data and/or signals to and from the first processor 210. For example, the second processor 220 may receive the periodic signal (e.g., a pulse signal) from the first processor 210. While receiving the periodic signal (e.g., a pulse signal) from the first processor 210, the second processor 220 may be deactivated. In other words, the second processor 220 may not output a control signal to the second parking brake driver 260 while receiving the periodic signal from the first processor 210.

However, the second processor 220 may be activated if not receiving the periodic signal (e.g., a pulse signal) from the first processor 210. The first processor 210 may periodically transmit a signal (e.g., pulse signals) to the second processor 220 during the normal operation of the first processor 210. The first processor 210 may not or cannot transmit a signal (e.g., a pulse signal) to the second processor 220 if the first processor 210 is not in a normal operation due to a failure or the like. As described above, when the second processor 220 does not receive the periodic signal (e.g., a pulse signal) from the first processor 210, the second processor 220 may determine or identify that the first processor 210 is not in normal operation and may be activated to perform at least some of functions which have been performed by of the first processor 210. In other words, the second processor 220 may output a control signal to the second parking brake driver 260 while not receiving the periodic signal from the first processor 210.

The second processor 220 may control at least one or both of the first parking brake module 22 and the second parking brake module 32 based on an electrical signal (e.g. an engagement or disengagement signals) from the parking switch 170 while the second processor 220 is being activated.

The second processor 220 may include a second memory 221 configured to memorize or store programs and data for parking the vehicle based on the user's intent to park. Alternatively, the second memory 221 may not be included the second processor 220 and may be arranged outside of the second processor 220 and electrically connected to the second processor 220.

The second memory 221 may provide programs and data to the second processor 220 and store temporary data generated during computational operations of the second processor 220. The second memory 221 may include, for instance, but not limited to, a volatile memory, such as S-RAM or D-RAM, and a non-volatile memory, such as ROM, EPROM, or a flash memory.

The first processor 220 may provide an engagement or disengagement signal to at least one of the first parking brake module 22 and the second parking brake module 32 to engage or disengage the parking brake according to the program and data stored in the first memory 211. For example, the second processor 220 may provide engagement or disengagement signals to the second parking brake module 32, as illustrated in FIG. 2.

The hydraulic pressure driver 230 may receive a control signal from the first processor 210 and, in response to the control signal from the first processor 210, provide a driving current to the hydraulic pressure motor 156 of the hydraulic pressure supply unit 150 to drive the hydraulic pressure motor 156. For example, the hydraulic pressure driver 230 may, in response to the control signal from the first processor 210, provide the driving current to the hydraulic pressure motor 156 to move the hydraulic pressure piston 153 in a forward direction (e.g. in a direction toward the first chamber 151 of the hydraulic pressure supply unit 150) or provide the driving current to the hydraulic pressure motor 156 to move the hydraulic pressure piston 153 in a backward direction (e.g. in a direction toward the second chamber 152 of the hydraulic pressure supply unit 150). The hydraulic pressure driver 230 may include, for example, but not limited to, an inverter circuit, or a circuit comprising switches, configured to control the driving current of the hydraulic pressure motor 156 and a gate driver configured to drive an input terminal of the inverter circuit.

The valve driver 240 may receive the control signal from the first processor 210 and, in response to the control signal from the first processor 210, provide the driving current for driving a valve to the valve block 161 of the hydraulic pressure control unit 160 to drive the valve block 161. For example, the hydraulic pressure driver 230 may, in response to the control signal from the first processor 210, provide the driving current to the valves included in the valve block 161 such that a flow path may be formed from the first hydraulic pressure chamber 151 of the hydraulic pressure supply unit 150 to the wheel cylinders 11, 21, 31, and 41, or provide the driving current to the valves included in the valve block 161 such that a flow path may be formed from the first hydraulic pressure chamber 151 of the hydraulic pressure supply unit 150 to the wheel cylinders 11, 21, 31, and 41.

The first parking brake driver 250 may receive an engagement or disengagement signal from at least one of the first processor 210 and the second processor 220, and provide the driving current to the first parking brake motor 181 to engage the parking brake in response to the received engagement or disengagement signal. For example, the first parking brake driver 250 may, in response to the received control signal, provide the first parking brake motor 181 with the driving current to move the brake caliper to restrain the rotation of the second wheel 20 and/or provide the first parking brake motor 181 with the driving current to move the brake caliper to release the restraint of the brake disc. The first parking brake driver 250 may include, for example, but not limited to, an H-bridge circuit configured to control the driving current of the hydraulic pressure motor 156 and a gate driver configured to drive an input terminal of the H-bridge circuit.

The second parking brake driver 260 may receive an engagement or disengagement signal from at least one of the first processor 210 and the second processor 220, and provide the driving current to the second parking brake motor 182 to engage the parking brake in response to the received engagement or disengagement signal. For example, the second parking brake driver 260 may, in response to the received control signal, provide the second parking brake motor 182 with the driving current to move the brake caliper to restrain the rotation of the third wheel 30 and/or provide the second parking brake motor 182 with the driving current to move the brake caliper to release the restraint of the brake disc. The second parking brake driver 260 may include, for example, an H-bridge circuit configured to control the driving current of the hydraulic pressure motor 156 and a gate driver configured to drive an input terminal of the H-bridge circuit.

As described above, the brake apparatus 100 includes the first processor 210, and the first processor 210 may control the brake apparatus 100 to brake the vehicle or engage the parking brake in response to the user's intent to brake or the user's intent to park. In addition, the brake apparatus 100 may further include the second processor 220 to provide redundancy of a processor for controlling a service brake and a parking brake. The second processor 220 may restrain the movement of the vehicle in response to the user's intent to park in place of the first processor 210 when the first processor 210 is not operating normally. Accordingly, the brake apparatus 100 may engage the parking brake by an operation of the second processor 220 even if the first processor 210 is not operating normally.

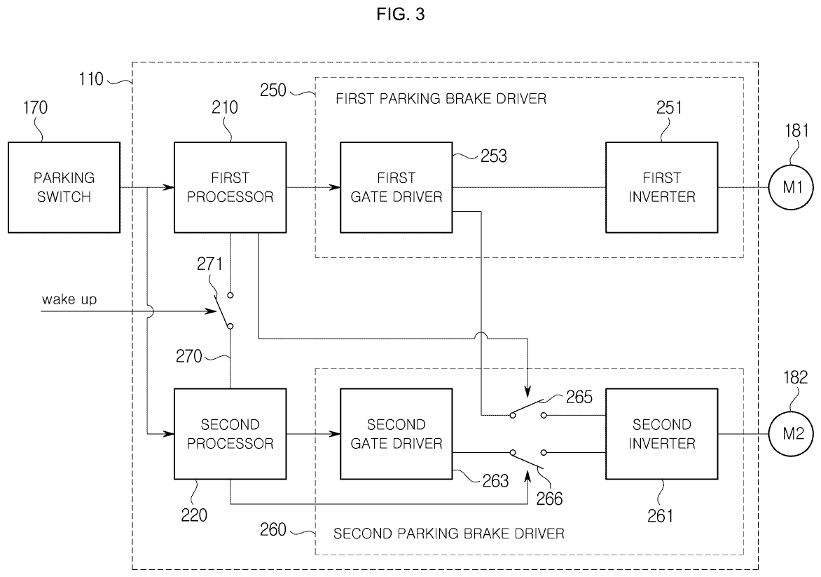

FIG. 3 is a block diagram for illustrating a processor and a parking brake driver of a control circuit included in a brake apparatus according to an embodiment of the present disclosure.

With reference to FIG. 3, the brake apparatus 100 may include the parking switch 170, the control circuit 110, the first parking brake motor 181, and the second parking brake motor 182. The parking switch 170, the first parking brake motor 181, and the second parking brake motor 182 of FIG. 3 may be the same as or similar to the parking switch 170, the first parking brake motor181, and the second parking brake motor 182 described above with reference to FIG. 2.

The control circuit 110 may include the first processor 210, the second processor 220, a signal line 270, a connection switch 271, the first parking brake driver 250, and the second parking brake driver 260. The first processor 210 and the second processor 220 of FIG. 3 may be the same as or similar to the first processor 210 and the second processor 220 described above with reference to FIG. 2.

The first processor 210 and the second processor 220 may be connected by the signal line 270. The first processor 210 may transmit and receive data and/or signals to and from the second processor 220 through the signal line 270. For example, the first processor 210 may transmit or provide a periodic signal (e.g., a pulse signal) to the second processor 220 through the signal line 270. The second processor 220 may be deactivated while the second processor 220 is receiving the periodic signal (e.g., a pulse signal) through the signal line 270, and may be activated when the second processor 220 is not receiving the periodic signal (e.g., a pulse signal) through the signal line 270.

A connection switch 271 may be arranged on the signal line 270 to allow or block signals from passing through the signal line 270.

While the connection switch 271 is turned on (i.e. closed to connect between the first processor 210 and the second processor 220 through the signal line 270), the first processor 210 may transmit or provide the periodic signal (e.g., a pulse signal) to the second processor 220 through the signal line 270. In addition, while the connection switch 271 is turned off (i.e. open to disconnect between the first processor 210 and the second processor 220), the first processor 210 may not transmit or provide the periodic signal (e.g., a pulse signal) to the second processor 220.

The connection switch 271 may be controlled by a device that is external to the brake apparatus 100. For instance, the connection switch 271 may be turned on or off by a wakeup signal from an external device arranged outside the brake apparatus 100.

The external device may be a variety of devices. For example, the external device may be a battery that supplies power to electrical components of the vehicle, or a power control device that controls the power supplied to the electrical components of the vehicle. The external device may be a device of opening or closing a door or a device of locking a door that is capable of detecting the user's exiting from the vehicle and/or entering into the vehicle. In addition, the external device may be a body control module (BCM) that controls operations of the electronic devices in the vehicle.

As described above, the connection switch 271 may be arranged separately from the brake apparatus 100 and controlled by an external device that operates independently from the brake apparatus 100.

Accordingly, the second processor 220 may control the second parking brake module 32 to restrain rotation of the third wheel 30 regardless of whether the first processor 210 is operating normally. For example, before the user depresses the brake pedal 50 after entering the vehicle or before starting the vehicle, the second processor 220 may engage the parking brake or keep maintaining a state that the parking brake is engaged independently from the first processor 210.

The first parking brake driver 250 and the second parking brake driver 260 may control the driving current of the first parking brake motor 181 and the driving current of the second parking brake motor 182 in response to the control signal from the first processor 210 during the normal operation of the first processor 210. In addition, the second parking brake driver 260 may control the driving current of the second parking brake motor 182 in response to a control signal from the second processor 220 when the first processor 210 is not operating normally.

The first parking brake driver 250 may include a first inverter 251 and a first gate driver 253. Either or both of the first inverter 251 and the first gate driver 253 may not be essential components of the first parking brake driver 250, and either or both of them may be omitted.

The second parking brake driver 260 may include a second inverter 261, a second gate driver 263, a first switch 265, and a second switch 266. One or more of the second inverter 261, the second gate driver 263, the first switch 265, and the second switch 266 may be not essential components of the second parking brake driver 260, and one or more of them may be omitted.

The first inverter 251 is electrically connected or arranged between the first processor 210 and the first parking brake motor 181, and may control the driving current of the first parking brake motor 181 in response to the control signal of the first processor 210. For example, the first inverter 251 may supply a driving current for rotating the first parking brake motor 181 in a first direction to the first parking brake motor 181 in response to a control signal for rotating the first parking brake motor 181 in the first direction.

The first inverter 251 may be implemented in a variety of topologies depending on the type of first parking brake motor 181. For example, when the first parking brake motor 181 includes a three-phase type motor, the first inverter 251 may include a three-phase type inverter circuit. In addition, when the first parking brake motor 181 includes a single-phase type motor, the first inverter 251 may include the H-bridge circuit.

The first gate driver 253 is electrically connected or arranged between the first processor 210 and the first and second inverters 251 and 261, and may drive the input terminals of the first and second inverters 251 and 261 in response to the control signal of the first processor 210.

A larger current at a high voltage may be required to drive the first parking brake motor 181. For this reason, the first inverter 251 may include power semiconductor components or elements capable of controlling a large current at a high voltage. In contrast, a smaller current at a low voltage may be required to reduce power consumption of the first processor 210. For this reason, the first inverter 251 may include micro-semiconductor components or elements capable of controlling a smaller current at a low voltage.

The first gate driver 253 may be connected between the first processor 210 and the first and second inverters 251 and 261 to amplify the control signal of the first processor 210 and provide the amplified control signal to the first and second inverters 251 and 261, respectively. In other words, the first gate driver 253 may drive the input terminals of the first and second inverters 251 and 261 in response to the control signal received from the first processor 210.

The second inverter 261 is electrically connected or arranged between the second processor 220 and the second parking brake motor 182, and may control the driving current of the second parking brake motor 182 in response to the control signal of the second processor 220.

The configuration and operation of the second inverter 261 may be the same as or similar to the configuration and operation of the first inverter 251.

The second gate driver 263 is electrically connected or arranged between the second processor 220 and the second inverter 261 and may drive the input terminal of the second inverter 261 in response to the control signal of the second processor 220.

The configuration and operation of the second gate driver 263 may be the same as or similar to the configuration and operation of the first gate driver 253.

The first and second switches 265 and 266 may be connected or arranged between the first and second gate drivers 253 and 263 and the second inverter 261. For example, the first switch 265 may be connected or arranged between the first gate driver 253 and the second inverter 261, and the second switch 266 may be connected or arranged between the second gate driver 263 and the second inverter 261.

The first switch 265 may allow or block a control signal to be or from being transmitted from the first gate driver 253 to the second inverter 261.

The first processor 210 may provide a first on/off signal to the first switch 265 to turn the first switch 265 on (i.e. closed) or off (i.e. open). The first switch 265 may allow or block the control signal to be or from being transmitted from the first gate driver 253 to the second inverter 261 in response to the first-on/off-signal from the first processor 210. For example, the first switch 265 may allow the control signal to be transmitted from the first gate driver 253 to the second inverter 261 in response to the first on signal from the first processor 210, and block the control signal transmitted from the first gate driver 253 to the second inverter 261 in response to the first off signal from the first processor 210.

The first processor 210 may provide the first-on-signal to the first switch 265 while operating normally. In addition, the first processor 210 may provide the first-off-signal to the first switch 265 while not operating normally. Accordingly, the first switch 265 may allow the control signal to be transmitted from the first gate driver 253 to the second inverter 261 when the first processor 210 is operating normally, and may block the control signal from being transmitted from the first gate driver 253 to the second inverter 261 when the first processor 210 is operating abnormally or not operating normally.

As described above, the first switch 265 may allow the control signal to be transmitted from the first gate driver 253 to the second inverter 261 when the first processor 210 is operating normally, and block the control signal from being transmitted from the first gate driver 253 to the second inverter 261 when the first processor 210 is not operating normally.

The second switch 266 may allow or block a control signal to be or from being transmitted from the second gate driver 263 to the second inverter 261.

The second processor 220 may provide a second-on/off-signal to the second switch 266 to turn the second switch 266 on (i.e. closed) or off (i.e. open). The second switch 266 may allow or block the control signal to be or from being transmitted from the second gate driver 263 to the second inverter 261 in response to the second-on/off-signal from the first processor 220. For example, the second switch 266 may allow the control signal to be transmitted from the second gate driver 263 to the second inverter 261 in response to a second-on-signal from the second processor 220, and block the control signal from being transmitted from the second gate driver 263 to the second inverter 261 in response to the second-off-signal from the second processor 220.

The second processor 220 may transmit or provide the second-off-signal to the second switch 266 while the second processor 220 is deactivated. In addition, the second processor 220 may transmit or provide the second-on-signal to the second switch 266 while the second processor 220 is activated. Accordingly, the second switch 266 may block the control signal from being transmitted from the second gate driver 263 to the second inverter 261 when the second processor 220 is being deactivated, and allow the control signal to be transmitted from the second gate driver 263 to the second inverter 261 when the second processor 220 is being activated. As described above, the second switch 266 may allow the control signal to be transmitted from the second gate driver 263 to the second inverter 261 when the first processor 210 is operating normally, and block the control signal from being transmitted from the second gate driver 263 to the second inverter 261 when the first processor 210 is not operating normally.

The second inverter 261 may receive the control signal from the first gate driver 253 while the first processor 210 is operating normally and receive the control signal from the second gate driver 263 while the first processor 210 is not operating normally.

As described above, the brake apparatus 100 may include the first processor 210 and the second processor 220. The first processor 210 may periodically transmit or provide signals (e.g., pulsed signals) to the second processor 220 through the signal line 270, on which the connection switch 271 is arranged, during the normal operation of the first processor 210. The first processor 210 may control the first parking brake module 22 of the second wheel 20 and the second parking brake module 32 of the third wheel 30 while the first processor 210 provides the periodic signal to the second processor 220. In addition, the second processor 220 is deactivated while the second processor 220 receives the periodic signal from the first processor 210, and may control the second parking brake module 32 of the third wheel 30 when the second processor 220 does not receive the periodic signal from the first processor 210.

Accordingly, the brake apparatus 100 may control the parking brake of the vehicle by the second processor 220 so that the brake apparatus 100 can operate the brake of the vehicle even if the first processor 210 is not operating normally.

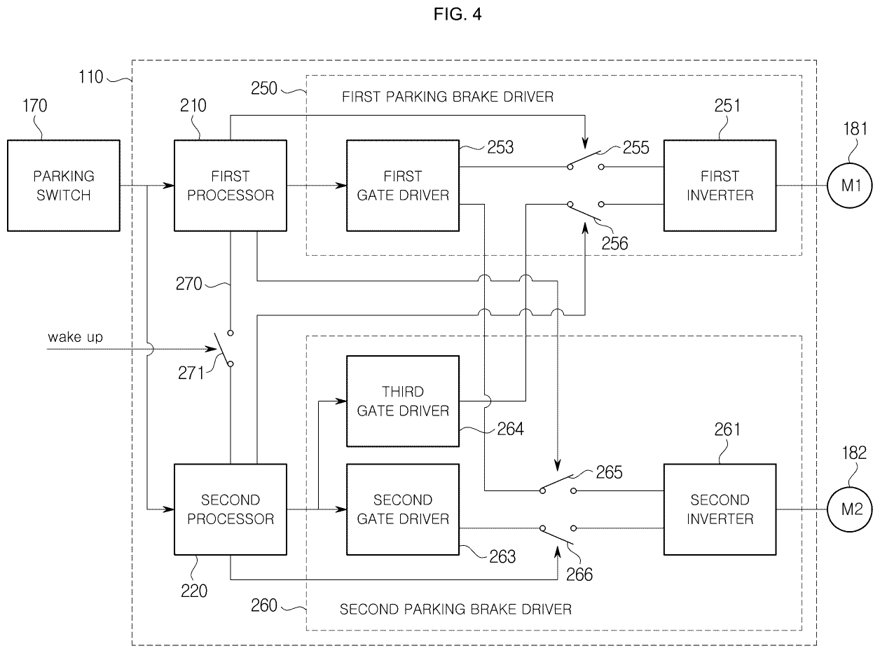

FIG. 4 is a block diagram for illustrating a processor and a parking brake driver of a control circuit included in a brake apparatus according to an embodiment of the present disclosure.

With reference to FIG. 4, the brake apparatus 100 may include the parking switch 170, the control circuit 110, the first parking brake motor 181, and the second parking brake motor 182. The parking switch 170, the first parking brake motor 181, and the second parking brake motor 182 of FIG. 4 may be the same as or similar to the parking switch 170, the first parking brake motor 181, and the second parking brake motor 182 described above with reference to FIG. 2.

The control circuit 110 may include the first processor 210, the second processor 220, a signal line 270, a connection switch 271, the first parking brake driver 250, and the second parking brake driver 260. The first processor 210 and the second processor 220 of FIG. 4 may be the same as or similar to the first processor 210 and the second processor 220 described above with reference to FIG. 2. In addition, the signal line 270 and the connection switch 271 of FIG. 4 may be the same as or similar to the connection switch 271 described above with reference to FIG. 3.

The first parking brake driver 250 may include the first inverter 251, the first gate driver 253, a third switch 255, and a fourth switch 256. One or more of the first inverter 251, the first gate driver 253, the third switch 255, and the fourth switch 256 may not be essential components of the first parking brake driver 250, and one or more of them may be omitted.

The second parking brake driver 260 may include the second inverter 261, the second gate driver 263, the third gate driver 264, the first switch 265, and the second switch 266. One or more of the second inverter 261, the second gate driver 263, the third gate driver 264, the first switch 265, and the second switch 266 may not be essential components of the second parking brake driver 260, and one or more of them may be omitted.

The first inverter 251 and first gate driver 253 of FIG. 4 may be the same as or be similar to the first inverter 251 and first gate driver 253 described above with reference to FIG. 3.

The second inverter 261, the second gate driver 263, the first switch 265, and the second switch 266 of FIG. 4 may be the same as or similar to the second inverter 261, the second gate driver 263, the first switch 265, and the second switch 266 described above with reference to FIG. 3.

The third gate driver 264 is electrically connected or arranged between the second processor 220 and the first inverter 251 and may drive the input terminal of the first inverter 251 in response to the control signal of the second processor 220.

The configuration and operation of the third gate driver 264 may be the same as or similar to the configuration and operation of the second gate driver 263.

The third switch 255 may allow or block a control signal to be or from being transmitted from the first gate driver 253 to the second inverter 251.

The first processor 210 may transmit or provide a third-on/off-signal to the third switch 255 to turn the third switch 255 on (i.e. closed) or off (i.e. open). The third switch 255 may allow or block the control signal to be or from being transmitted from the first gate driver 253 to the first inverter 251 in response to the third-on/off-signal from the first processor 210. For example, the third switch 255 may allow the control signal to be transmitted from the first gate driver 253 to the first inverter 251 in response to the third-on-signal from the first processor 210, and block the control signal from being transmitted from the first gate driver 253 to the first inverter 251 in response to the third-off-signal from the first processor 210.

The first processor 210 may provide the third-on-signal to the third switch 255 while the first processor 210 operates normally. In addition, the first processor 210 may transmit or provide the third-off-signal to the third switch 255 while the first processor 210 does not operate normally. Accordingly, the third switch 255 may allow the control signal to be transmitted from the first gate driver 253 to the first inverter 251 when the first processor 210 is operating normally, and block the control signal from being transmitted from the first gate driver 253 to the first inverter 251 when the first processor 210 is not operating normally.

As described above, the third switch 255 may allow the control signal to be transmitted from the first gate driver 253 to the first inverter 251 when the first processor 210 is operating normally, and block the control signal from being transmitted from the first gate driver 253 to the first inverter 251 when the first processor 210 is not operating normally.

The fourth switch 256 may allow or block a control signal to be or from being transmitted from the third gate driver 264 to the second inverter 261.

The second processor 220 may transmit or provide a fourth-on/off-signal to the second switch 266 to turn the fourth switch 256 on (i.e. closed) or off (i.e. open). The fourth switch 256 may allow or block the control signal to be or from being transmitted from the third gate driver 264 to the first inverter 251 in response to the fourth-on/off-signal from the second processor 220. For example, the fourth switch 256 may allow the control signal to be transmitted from the third gate driver 264 to the first inverter 251 in response to the fourth-on-signal from the second processor 220, and block the control signal from being transmitted from the third gate driver 264 to the first inverter 251 in response to the fourth-off-signal from the second processor 220.

The second processor 220 may transmit or provide the fourth-off-signal to the fourth switch 256 while the second processor 220 is deactivated. In addition, the second processor 220 may transmit or provide the fourth-on-signal to the fourth switch 256 while the second processor 220 is activated. Accordingly, the fourth switch 256 may block the control signal from being transmitted from the third gate driver 264 to the first inverter 251 when the second processor 220 is being deactivated, and allow the control signal to be transmitted from the third gate driver 264 to the first inverter 251 when the second processor 220 is being activated.

As described above, the fourth switch 256 may block the control signal from being transmitted from the third gate driver 264 to the first inverter 251 when the first processor 210 is operating normally, and allow the control signal to be transmitted from the third gate driver 264 to the first inverter 251 when the first processor 210 is not operating normally.

The first inverter 251 may receive the control signal from the first gate driver 253 while the first processor 210 is operating normally and receive the control signal from the third gate driver 264 while the first processor 210 is not operating normally.

As described above, the brake apparatus 100 may include the first processor 210 and the second processor 220. The first processor 210 may periodically provide a signal (e.g., a pulse signal) to the second processor 220. The first processor 210 may control the first parking brake module 22 of the second wheel 20 and the second parking brake module 32 of the third wheel 30 while the first processor 210 provides the periodic signal to the second processor 220. In addition, the second processor 220 is deactivated while the second processor 220 is receiving the periodic signal from the first processor 210 and may control the first parking brake module 22 of the second wheel 20 and the second parking brake module 32 of the third wheel 30 when the periodic signal is not being received from the first processor 210.

Accordingly, the brake apparatus 100 may control the parking brake of the vehicle by the second processor 220 so that the brake apparatus 100 can operate the brake of the vehicle even if the first processor 210 is not operating normally.

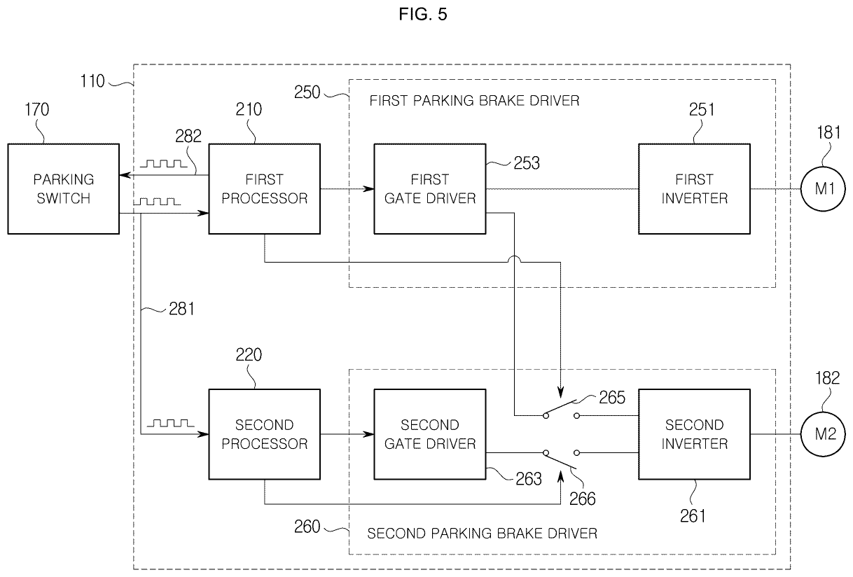

FIG. 5 is a block diagram for illustrating a processor and a parking brake driver of a control circuit included in a brake apparatus according to a still another embodiment of the present disclosure.

With reference to FIG. 5, the brake apparatus 100 may include the parking and the second parking brake motor 182 of FIG. 5 may be the same as or similar to the parking switch 170, the first parking brake motor 181, and the second parking brake motor 182 described above with reference to FIG. 2.

The control circuit 110 may include the first processor 210, the second processor 220, a first external line 281, a second external line 282, the first parking brake driver 250, and the second parking brake driver 260. The first processor 210 and the second processor 220 of FIG. 5 may be the same as or similar to the first processor 210 and the second processor 220 described above with reference to FIG. 2. In addition, the first parking brake driver 250 and the second parking brake driver 260 of FIG. 5 may be the same as or similar to the first parking brake driver 250 and the second parking brake driver 260 described above with reference to FIG. 3.

The first external line 281 may electrically connect the parking switch 170 and the first and second processors 210 and 220. In addition, the second external line 282 may electrically connect the first processor 210 and the parking switch 170.

The parking switch 170 may receive or obtain an input for engaging or disengaging the parking brake from the user, and transmit or provide an electrical signal (an engagement or disengagement signal) indicating the user's input for engaging or disengaging the parking brake to the first and second processors 210 and 220 through the first external line 281. The first and second processors 210 and 220 may receive an engagement or disengagement signal from the parking switch 170 through the first external line 281.

The first processor 210 may transmit or provide a control signal to the first gate driver 253 to engage or disengage the parking brake based on the engagement or disengagement signal received from the parking switch 170 during the normal operation of the first processor 210.

The first processor 210 may transmit a periodic signal (e.g., a pulse signal) to the parking switch 170 through the second external line 282 based on the engagement or disengagement signal from the parking switch 170 during the normal operation of the first processor 210. For example, the first processor 210 may transmit the periodic signal (e.g., a pulse signal) to the parking switch 170 while engaging or disengaging the parking brake.

The parking switch 170 may receive the periodic signal from the first processor 210 through the second external line 282 during the normal operation of the first processor 210. The parking switch 170 may determine or identify that the first processor 210 is operating normally based on the periodic signal received from the first processor 210.

The parking switch 170 may transmit the periodic signal to the first and second processors 210 and 220 through the first external line 281 in response to the periodic signal received from the first processor 210.

The second processor 220 may determine or identify that the first processor 210 is operating normally based on the received periodic signal (e.g., a pulse signal) from the first parking switch 170 through the first external line 281. Accordingly, the second processor 220 may be deactivated while the second processor 220 receives the periodic signal (e.g., a pulse signal) from the parking switch 170.

The first processor 210 may not transmit the periodic signal (e.g., a pulse signal) to the parking switch 170 if the first processor 210 is operating abnormally or is not operating normally.

The parking switch 170 may not receive the periodic signal from the first processor 210 when the first processor 210 is not operating normally. The parking switch 170 may determine or identify that the first processor 210 is not operating normally when the parking switch 170 is not receiving the periodic signal from the first processor 210.

The parking switch 170 may not transmit the periodic signal to the first and second processors 210 and 220 if the parking switch 170 is not receiving the periodic signal from the first processor 210.

The second processor 220 may determine or identify that the first processor 210 is not operating normally if the second processor 220 is not receiving the periodic signal (e.g., a pulse signal) from the parking switch 170. Accordingly, the second processor 220 may be activated if the second processor 220 does not receive the periodic signal (e.g., a pulse signal) from the parking switch 170. The second processor 220 may control the parking brake of the vehicle if the second processor 220 does not receive the periodic signal (e.g., pulse signal) from the parking switch 170.

As described above, the brake apparatus 100 may include the first processor 210 and the second processor 220. Both the first processor 210 and the second processor 220 are connected to the parking switch 170, and the first processor 210 may periodically provide a signal (e.g., a pulse signal) to the second processor 220 through the parking switch 170 during the normal operation of the first processor 210, and may control the parking brake. The second processor 220 is deactivated while the second processor 220 periodically receives the periodic signal from the parking switch 170, and is activated to control the parking brake when the second processor 220 does not receive the periodic signal from the parking switch 170.

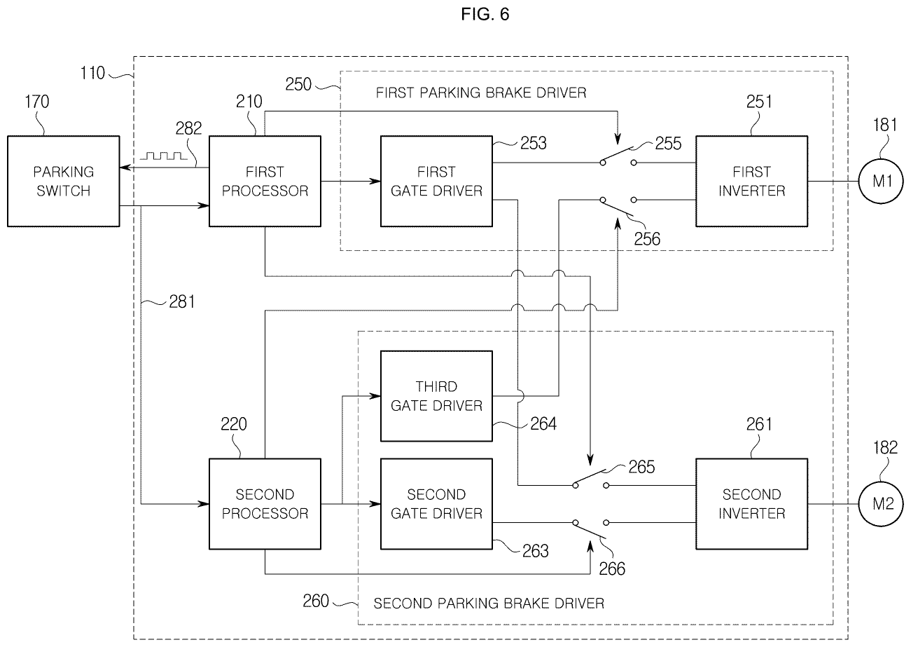

Accordingly, the brake apparatus 100 may control the parking brake of the vehicle by the second processor 220 so that the brake apparatus 100 can operate the brake of the vehicle even if the first processor 210 is not operating normally. FIG. 6 is a block diagram for illustrating a processor and a parking brake driver of a control circuit included in a brake apparatus according to still another embodiment of the present disclosure.

With reference to FIG. 6, the brake apparatus 100 may include the parking switch 170, the control circuit 110, the first parking brake motor 181, and the second parking brake motor 182. The parking switch 170, the first parking brake motor 181, and the second parking brake motor 182 of FIG. 6 may be the same as or similar to the parking switch 170, the first parking brake motor 181, and the second parking brake motor 182 described above with reference to FIG. 2.

The control circuit 110 may include the first processor 210, the second processor 220, the first external line 281, the second external line 282, the first parking brake driver 250, and the second parking brake driver 260. The first processor 210 and the second processor 220 of FIG. 6 may be the same as the first processor 210 and the second processor 220 described above with reference to FIG. 2. In addition, the first external line 281 and the second external line 282 of FIG. 6 may be the same as the first external line 281 and the second external line 282 described above with reference to FIG. 3.

The first parking brake driver 250 may include the first inverter 251, the first gate driver 253, the third switch 255, and the fourth switch 256. One or more of the first inverter 251, the first gate driver 253, the third switch 255, and the fourth switch 256 may not be essential components of the first parking brake driver 250, and one or more of them may be omitted. The first inverter 251 and first gate driver 253 of FIG. 6 may be the same as or similar to the first inverter 251 and first gate driver 253 described above with reference to FIG. 3. The third switch 255 and the fourth switch 256 of FIG. 6 may be the same as or similar to the third and fourth switches 255 and 256 described above with reference to FIG. 4.

The second parking brake driver 260 may include the second inverter 261, the second gate driver 263, the third gate driver 264, the first switch 265, and the second switch 266. One or more of the second inverter 261, the second gate driver 263, the third gate driver 264, the first switch 265, and the second switch 266 may not be essential components of the second parking brake driver 260, and one or more of them may be omitted. One or more of the second inverter 261, the second gate driver 263, the first switch 265, and the second switch 266 of FIG. 6 may be the same as or similar to the second inverter 261, the second gate driver 263, the first switch 265, and the second switch 266 described above with reference to FIG. 3. The third gate driver 264 of FIG. 6 may be the same as or similar to the third gate driver 264 described above with reference to FIG. 4.

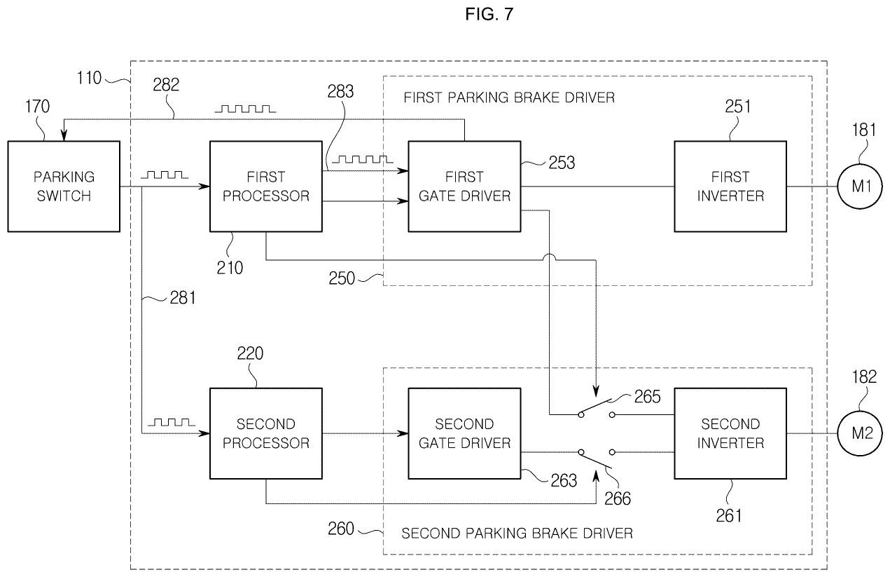

FIG. 7 is a block diagram of illustrating a processor and a parking brake driver of a control circuit included in a brake apparatus according to still another embodiment of the present disclosure.

The brake apparatus 100 may include the parking switch 170, the control circuit 110, the first parking brake motor 181, and the second parking brake motor 182. The parking switch 170, the first parking brake motor 181, and the second parking brake motor 182 of FIG. 7 may be the same as or similar to the parking switch 170, the first parking brake motor 181, and the second parking brake motor 182 described above with reference to FIG. 2.

The control circuit 110 may include the first processor 210, the second processor 220, the first external line 281, the second external line 282, an internal line 283, the first parking brake driver 250, and the second parking brake driver 260. The first processor 210 and the second processor 220 of FIG. 7 may be the same as or similar to the first processor 210 and the second processor 220 described above with reference to FIG. 2. In addition, the first parking brake driver 250 and the second parking brake driver 260 of FIG. 7 may be the same as or similar to the first parking brake driver 250 and the second parking brake driver 260 described above with reference to FIG. 3.

The first external line 281 may electrically connect the parking switch 170 and the first and second processors 210 and 220. The internal line 283 may electrically connect the first processor 210 and the first gate driver 253. The second external line 282 may electrically connect the first gate driver 253 and the parking switch 170.

The parking switch 170 may receive or obtain an input for engaging or disengaging the parking brake from the user, and transfer or provide an electrical signal (e.g. an engagement or disengagement signal) indicating the user's input for engaging or disengaging the parking brake to the first and second processors 210 and 220 through the first external line 281. The first and second processors 210 and 220 may receive an engagement or disengagement signal from the parking switch 170 through the first external line 281.

The first processor 210 may transmit or provide a control signal to the first gate driver 253 to engage or disengage the parking brake based on the engagement or disengagement signal received from the parking switch 170 during the normal operation of the first processor 210.

The first processor 210 may transmit the periodic signal (e.g., a pulse signal) to the first gate driver 253 through the internal line 283 in response to the engagement or disengagement signal received from the parking switch 170 during the normal operation of the first processor 210. For example, the first processor 210 may transmit the periodic signal (e.g., a pulse signal) to the first gate driver 253 while engaging or disengaging the parking brake.

The first gate driver 253 may control the first and second inverters 251 and 261 to provide a driving current to the first and second parking brake motors 181 and 182 based on the control signal from the first processor 210 during a normal operation of the first gate driver 253.

The first gate driver 253 may transmit the periodic signal (e.g., a pulse signal) to the parking switch 170 through the second external line 282 in response to the periodic signal received from the first processor 210 during the normal operation of the first gate driver 253. For example, the first gate driver 253 may transmit the periodic signal (e.g., a pulse signal) to the parking switch 170 while engaging or disengaging the parking brake.

The parking switch 170 may receive the periodic signal from the first gate driver 253 through the second external line 282 during the normal operation of the first processor 210 and the first gate driver 253. The parking switch 170 may determine or identify that the first processor 210 and the first gate driver 253 are operating normally based on the periodic signal received from the first gate driver 253.

The parking switch 170 may transmit the periodic signal to the first and second processors 210 and 220 through the first external line 281 in response to the periodic signal received from the first gate driver 253.

The second processor 220 may determine or identify that the first processor 210 and the first gate driver 253 are operating normally based on the periodic signal (e.g., a pulse signal) from the first parking switch 170 through the first external line 281. Accordingly, the second processor 220 may be deactivated while the second processor 220 periodically receives the periodic signal (e.g., a pulse signal) from the parking switch 170.

The first processor 210 may not or cannot transmit the periodic signal (e.g., a pulse signal) to the first gate driver 253 if the first processor 210 is operating abnormally or is not operating normally. In addition, the first gate driver 253 may not transmit the periodic signal (e.g., a pulse signal) to the parking switch 170 if the first processor 210 is not operating normally.

The parking switch 170 may not receive the periodic signal from the first gate driver 253 unless at least one of the first processor 210 and the first gate driver 253 is operating normally. The parking switch 170 may determine or identify that at least one of the first processor 210 and the first gate driver 253 is not operating normally if the parking switch 170 does not receive the periodic signal from the first gate driver 253.

The parking switch 170 may not transmit the periodic signal to the first and second processors 210 and 220 if the parking switch 170 does not receive the periodic signal from the first gate driver 253.

The second processor 220 may determine or identify that at least one of the first processor 210 and the first gate driver 253 is not operating normally if the second processor 220 does not receive the periodic signal (e.g., pulse signal) from the parking switch 170. Accordingly, the second processor 220 may be activated if the second processor 220 does not receive the periodic signal (e.g., a pulse signal) from the parking switch 170. The second processor 220 may control the parking brake of the vehicle if the second processor 220 does not receive the periodic signal (e.g., a pulse signal) from the parking switch 170.

As described above, the brake apparatus 100 may include the first processor 210 and the second processor 220. Both the first processor 210 and the second processor 220 are connected to the parking switch 170, and the first processor 210 and the first gate driver 253 may periodically transmit or provide a signal (e.g., a pulse signal) to the second processor 220 through the parking switch 170 during the normal operations of the first processor 210 and the first gate driver 253, and may control the parking brake. The second processor 220 is deactivated while the second processor 220 periodically receives the periodic signal from the parking switch 170, and is activated when the second processor 220 does not receive the periodic signal from the parking switch 170 to control the parking brake.

Accordingly, the brake apparatus 100 may control the parking brake of the vehicle by the second processor 220 so that the brake apparatus 100 can operate the brake of the vehicle even if at least one of the first processor 210 and the first gate driver 253 is not operating normally.

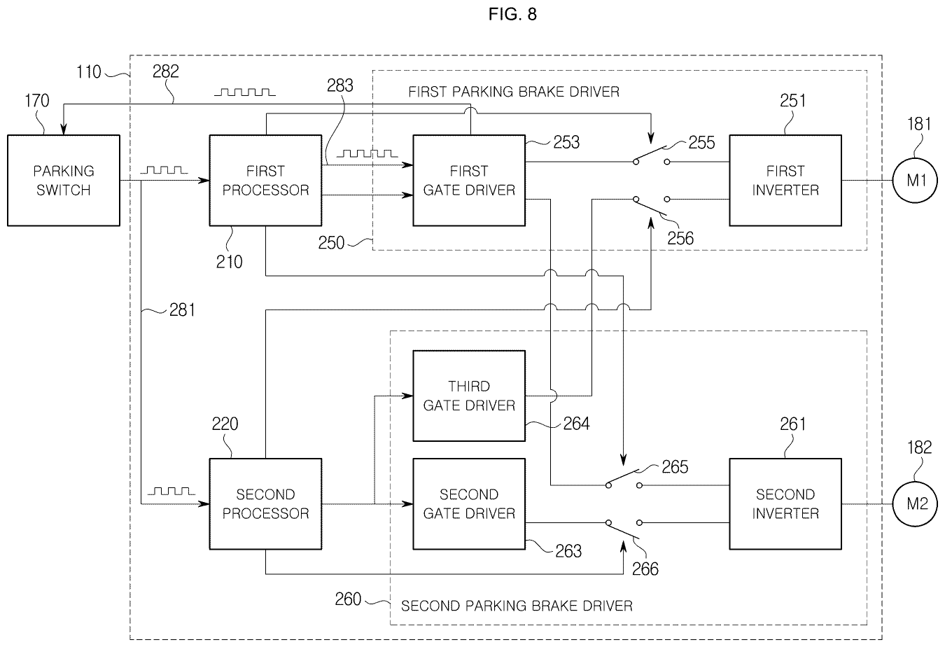

FIG. 8 is a block diagram for illustrating a processor and a parking brake driver of a control circuit included in a brake apparatus according to still another embodiment of the present disclosure.

With reference to FIG. 8, the brake apparatus 100 may include the parking and the second parking brake motor 182 of FIG. 8 may be the same as or similar to the parking switch 170, the first parking brake motor 181, and the second parking brake motor 182 described above with reference to FIG. 2.

The control circuit 110 may include the first processor 210, the second processor 220, the first external line 281, the second external line 282, the internal line 283, the first parking brake driver 250, and the second parking brake driver 260. The first processor 210 and the second processor 220 of FIG. 8 may be the same as or similar to the first processor 210 and the second processor 220 described above with reference to FIG. 2. In addition, the first external line 281, the second external line 282, and the internal line 283 may be the same as or similar to the first external line 281, the second external line 282, and the internal line 283 described above with reference to FIG. 3.

The first parking brake driver 250 may include the first inverter 251, the first gate driver 253, the third switch 255, and the fourth switch 256. One or more of the first inverter 251, the first gate driver 253, the third switch 255, and the fourth switch 256 may not be essential components of the first parking brake driver 250, and one or more of them may be omitted. The first inverter 251 and first gate driver 253 of FIG. 8 may be the same as or similar to the first inverter 251 and first gate driver 253 described above with reference to FIG. 3. The third switch 255 and the fourth switch 256 of FIG. 8 may be the same as or similar to the third and fourth switches 255 and 256 described above with reference to FIG. 4.

The second parking brake driver 260 may include the second inverter 261, the second gate driver 263, the third gate driver 264, the first switch 265, and the second switch 266. One or more of the second inverter 261, the second gate driver 263, the third gate driver 264, the first switch 265, and the second switch 266 may be not essential components of the second parking brake driver 260, and one or more of them may be omitted. The second inverter 261, the second gate driver 263, the first switch 265, and the second switch 266 of FIG. 8 may be the same as or similar to the second inverter 261, the second gate driver 263, the first switch 265, and the second switch 266 described with reference to FIG. 3. The third gate driver 264 of FIG. 8 may be the same as or similar to the third gate driver 264 described above with reference to FIG. 4.

According to one aspect of the present disclosure, the brake apparatus may be capable of improving reliability, stability, and robustness of the parking brake.

Another aspect of the present disclosure can provide the brake apparatus including a main processor and a main driver, as well as a redundant processor and a redundant driver for controlling and driving a parking brake. Accordingly, the redundant processor and/or the redundant driver can be used to control the parking brake even if the main processor and/or the main driver fails.

Exemplary embodiments of the present disclosure have been described above. In the exemplary embodiments described above, some components may be implemented as a “module”. Here, the term ‘module’ means, but is not limited to, a software and/or hardware component, such as a Field Programmable Gate Array (FPGA) or Application Specific Integrated Circuit (ASIC), which performs certain tasks. A module may advantageously be configured to reside on the addressable storage medium and configured to execute on one or more processors.

Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The operations provided for in the components and modules may be combined into fewer components and modules or further separated into additional components and modules. In addition, the components and modules may be implemented such that they execute one or more CPUs in a device.

With that being said, and in addition to the above described exemplary embodiments, embodiments can thus be implemented through computer readable code/instructions in/on a medium, e.g., a computer readable medium, to control at least one processing element to implement any above described exemplary embodiment. The medium can correspond to any medium/media permitting the storing and/or transmission of the computer readable code.

The computer-readable code can be recorded on a medium or transmitted through the Internet. The medium may include Read Only Memory (ROM), Random Access Memory (RAM), Compact Disk-Read Only Memories (CD-ROMs), magnetic tapes, floppy disks, and optical recording medium. Also, the medium may be a non-transitory computer-readable medium. The media may also be a distributed network, so that the computer readable code is stored or transferred and executed in a distributed fashion. Still further, as only an example, the processing element could include at least one processor or at least one computer processor, and processing elements may be distributed and/or included in a single device.

While exemplary embodiments have been described with respect to a limited number of embodiments, those skilled in the art, having the benefit of this disclosure, will appreciate that other embodiments can be devised which do not depart from the scope as disclosed herein. Accordingly, the scope should be limited only by the attached claims.

What is claimed is:

1. A brake apparatus comprising:
a first processor configured to output a first control signal based on an output signal of a parking switch, and transmit a first periodic signal to the parking switch when the first processor is in a normal state;
a second processor configured to output a second control signal based on the output signal of the parking switch when the second processor does not receive a second periodic signal which is transmitted by the parking switch in response to the first period signal of the first processor;
a first parking brake driver configured to drive a first parking brake motor and a second parking brake motor based on the first control signal of the first processor; and
a second parking brake driver configured to drive the second parking brake motor based on the second control signal of the second processor.

2. The brake apparatus of claim 1, wherein:
the parking switch is configured not to transmit the second periodic signal to the second processor in response to not receiving the first periodic signal from the first processor, and
the second processor is configured not to output the second control signal in response to the second periodic signal received from the parking switch.

3. The brake apparatus of claim 1, wherein:
the first parking brake driver comprises:
a first inverter configured to provide a driving current to the first parking brake motor; and
a first gate driver configured to drive the first inverter based on the first control signal of the first processor,
the second parking brake driver comprises:
a second inverter configured to provide a driving current to the second parking brake motor; and
a second gate driver configured to drive the second inverter based on the second control signal of the second processor, and
the first gate driver of the first parking brake driver is further configured to drive the second inverter of the second parking brake driver based on the first control signal of the first processor.

4. The brake apparatus of claim 3, wherein the second parking brake driver further comprises:
a first switch connected between the first gate driver and the second inverter, the first switch configured to be turned on or off in response to a first signal for turning on or off the first switch from the first processor; and
a second switch connected between the second gate driver and the second inverter, the second switch configured to be turned on or off in response to a second signal for turning on or off the second switch from the second processor.

5. The brake apparatus of claim 4, wherein:
the first processor is configured to output the first signal to the first switch for the first switch to connect between the first gate driver and the second inverter when the first processor is in the normal state, and
the second processor is configured to output the second signal to the second switch for the second switch to disconnect between the second gate driver and the second inverter in response to the second periodic signal which is transmitted by the parking switch in response to the first period signal of the first processor.

6. The brake apparatus of claim 5, wherein:
the first switch is configured to disconnect between the first gate driver and the second inverter when the first processor is not in the normal state, and
the second processor is configured to output the second signal to the second switch for the second switch to connect between the second gate driver and the second inverter in response to not receiving the second periodic signal which is transmitted by the parking switch in response to the first period signal of the first processor.

7. The brake apparatus of claim 1, wherein the second parking brake driver is configured to drive the first parking brake motor and the second parking brake motor based on the second control signal of the second processor.

8. The brake apparatus of claim 1, wherein:
the first parking brake driver comprises:
a first inverter configured to provide a driving current to the first parking brake motor; and
a first gate driver configured to drive the first inverter based on the first control signal of the first processor,
the second parking brake driver comprises:
a second inverter configured to provide a driving current to the second parking brake motor;
a second gate driver configured to drive the second inverter of the second parking brake driver based on the second control signal of the second processor; and
a third gate driver configured to drive the first inverter of the first parking brake driver based on the second control signal of the second processor, and
wherein the first gate driver is further configured to drive the second inverter of the second parking brake driver based on the first control signal of the first processor.

9. The brake apparatus of claim 8, wherein the first parking brake driver further comprises:
a third switch connected between the first gate driver and the first inverter, the third switch configured to be turned on or off in response to a third signal for turning on or off the third switch from the first processor; and
a fourth switch connected between the third gate driver and the first inverter, the fourth switch configured to be turned on or off in response to a fourth signal for turning on or off the fourth switch from the second processor.

10. The brake apparatus of claim 9, wherein:
the first processor is configured to output the third signal to the third switch for the third switch to connect between the first gate driver and the first inverter when the first processor is in the normal state, and
the second processor is configured to output the fourth signal to the fourth switch for the fourth switch to disconnect between the third gate driver and the first inverter in response to the second periodic signal which is transmitted by the parking switch in response to the first period signal of the first processor.

11. The brake apparatus of claim 10, wherein:
the third switch is configured to disconnect between the first gate driver and the first inverter when the first processor is not in the normal state, and
the second processor is configured to output the fourth signal to the fourth switch for the fourth switch to connect between the third gate driver and the first inverter in response to not receiving the second periodic signal which is transmitted by the parking switch in response to the first period signal of the first processor.

12. The brake apparatus of claim 1, wherein each of the first periodic signal and the second periodic signal comprises a periodic pulse.

13. The brake apparatus of claim 1, further comprising:
a hydraulic pressure supply unit comprising a cylinder block and configured to supply a hydraulic pressure of a pressurized medium to one or more wheel cylinders; and
a hydraulic pressure control unit comprising a valve block and configured to control a flow path extending from the hydraulic pressure supply unit to the wheel cylinders,
wherein the first processor is configured to control the hydraulic pressure supply unit and the hydraulic pressure control unit to supply the hydraulic pressure to the wheel cylinders based on an output signal associated with a brake pedal.

14. The brake apparatus of claim 13, wherein the hydraulic pressure supply unit comprises:
a piston movably disposed within the cylinder block; and
a hydraulic pressure motor configured to move the piston.

15. The brake apparatus of claim 13, wherein the valve block of the hydraulic pressure control unit has a plurality of valves arranged on the flow path extending from the hydraulic pressure supply unit to the wheel cylinders.

16. A brake apparatus comprising:
a first processor configured to output a first control signal based on an output signal of a parking switch, and transmit a first periodic signal to the parking switch when the first processor is in a normal state;
a first parking brake driver configured to drive a first parking brake motor and a second parking brake motor based on the first control signal of the first processor, and transmit a second periodic signal to the parking switch in response to the first periodic signal received from the first processor;
a second processor configured to output a second control signal based on the output signal of the parking switch when the second processor does not receive a third periodic signal which is transmitted by the parking switch in response to the second period signal of the first parking brake driver; and
a second parking brake driver configured to drive the second parking brake motor based on the second control signal of the second processor.

17. The brake apparatus of claim 16, wherein:
the parking switch is configured not to transmit the third periodic signal to the second processor in response to not receiving the second periodic signal, and
the second processor is configured not to output the second control signal in response to the third periodic signal which is transmitted by the parking switch in response to the second period signal of the first parking brake driver.

18. A brake apparatus comprising:
a first processor configured to output a first control signal based on an output signal of a parking switch and transmit a periodic signal when the first processor is in a normal state;
a second processor configured to output a second control signal based on the output signal of the parking switch when the second processor does not receive the periodic signal from the first processor;
a connection switch arranged on a signal line connecting the first processor and the second processor;
a first parking brake driver configured to drive a first parking brake motor and a second parking brake motor based on the first control signal of the first processor; and
a second parking brake driver configured to drive the second parking brake motor based on the second control signal of the second processor,
wherein the periodic signal is transmitted from the first processor to the second processor through the signal line when the first processor is in the normal state.

19. The brake apparatus of claim 18, wherein the second processor is configured not to output the second control signal in response to the periodic signal from the first processor.

20. The brake apparatus of claim 18, wherein the connection switch is controlled by an external device which is disposed outside the brake apparatus.
